(19) United States
(12) Patent Application Publication
(10) Pub. No.: US 2026/0080684 A1
(43) Pub. Date: Mar. 19, 2026

(54) METHODS OF MONITORING THE ENVIRONMENT IN PROXIMITY TO A COMPUTER DEVICE

(71) Applicant: SPIalert LLC, Warentown, NJ (US)

(72) Inventors: Yan Auerbach, Warentown, NJ (US); Yevgeny Kushnir, Holmdel, NJ (US)

(21) Appl. No.: 18/886,344

(22) Filed: Sep. 16, 2024

(51) Int. Cl. G06V 20/52; G06F 21/84; G06V 40/16

(52) U.S. Cl. CPC G06V 20/52; G06F 21/84; G06V 40/172

(57) ABSTRACT

Disclosed are methods of monitoring the environment in proximity to a computer device for abnormal activity including identifying a user of the computer device and collecting user data, conducting a baseline session including using a video input component of the computer device and associated video analytics to establish normal activity for the environment in proximity to the computer device, conducting an active session on the computer device including using a computer device default video input component and associated video analytics to detect abnormal activity in the environment in proximity to the computer device by comparing the active session with the baseline session, and wherein the abnormal activity includes detecting when an object including a camera is being used by a user or a non-user to video or photograph the computer device display.

### BACKGROUND

### Technical Field of the Invention

This disclosure generally relates to the protection of computer devices and computer device screens from espionage.

### Description of the Related Art

Computer devices in various contexts including corporate, government, private, etc., are at risk from unwanted viewing including espionage by internal or external threats. While some systems are available to help reduce the likelihood of, for example, corporate espionage, there remains a critical need for improved systems and methods for protecting computer devices including user screens from threats including espionage.

### SUMMARY DISCLOSURE OF THE INVENTION

Disclosed are methods of monitoring the environment in proximity to a computer device for abnormal activity including identifying a user of the computer device and collecting user data, conducting a baseline session including using a computer video camera and associated video analytics to obtain user facial data, non-user facial data, and object data to establish normal activity for the environment in proximity to the computer device, monitoring an active session on the computer device including using a computer video camera and associated video analytics to obtain user facial data, non-user facial data, and object data to detect abnormal activity in the environment in proximity to the computer device by comparing the active session user facial data, non-user facial data, and object data with the baseline session user facial data, non-user facial data, and object data, wherein the abnormal activity includes: detecting when an object that includes a camera is being used to video or photograph the computer device display by a non-user, when non-users have visibility of the computer device display, the user is moving with the computer device while it is unlocked, a non-user is looking at the computer device display, the user is moving away from the computer device display, and/or detecting that the environment in proximity to the computer device is public; and enabling actions on the computer device to protect the computer device against data compromise.

The computer device may be a desktop, laptop, or tablet computer device. The video camera may be a webcam. The actions on the device to protect the device may include screen blackout, screen lock, user warning, policy reminder, or administrative interactive switches. The actions on the computer device to protect the computer device may be preconfigured or predefined prior to conducting the baseline monitoring session.

Other features and aspects will be apparent from the following detailed description, the drawings, and the claims.

### BRIEF DESCRIPTION OF THE DRAWINGS

FIG. 1 is a flow chart illustrating an embodiment of the invention.

FIG. 2 is a flowchart illustrating a startup and user login process.

FIG. 3 and FIG. 3 (Continued) show a flowchart illustrating an example of anomaly detection.

FIG. 4 is a flowchart illustrating example computer behavior abnormality detection.

FIG. 5 and FIG. 5 (Continued) show a flowchart illustrating an object identification process.

FIG. 6 and FIG. 6 (Continued) are flowcharts illustrating configured action processes; video to face identification processes; and environment identification processes.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

### MODES FOR CARRYING OUT THE INVENTION

In embodiments, the present invention includes the following steps.

Utilize a video input component (e.g., web cam) and video analytics to monitor and learn the physical environment around a subject device. This includes the creation of a baseline of normal activity using both facial and object detection around the subject computer device.

Recognize and record abnormal activity by comparing measured activity with the established baseline of normal activity.

Utilize recognized abnormal activity through facial recognition and objects in motion to determine if an object with image capturing capability is being used for possible espionage, an unexpected person(s) have access to content on the computer device display, credentials to login are used by unexpected user, and environment where computer device is located is prone to data theft.

When abnormal activity is detected, enable administrator pre-configured actions on the device to automatically reduce the likelihood of data compromise.

The establishment of baseline activity includes conducting a baseline session monitoring object, facial, and environmental data around the device. This will establish baseline behavior for both facial detection and objects in motion to define normal activities. This is done by using object and facial recognition with environmental orientation. The system can use video analytics to identify baseline common users in correlation to their login credentials by using facial recognition without the user's identity being preconfigured on the device. The system can also use video analytics to identify baseline common objects in motion in the vicinity of the device. This can include monitoring, by way of example, facial recognition to determine individual orientation and behavior including use of objects, and whether someone is looking at a device screen, and user keyboard actions.

An active session includes the identification of objects in motion and the use of facial recognition to identify common users and user orientation and behavior is then used to identify abnormal activity. The detection of abnormal activity is based on current activity and will include comparison of some of the same activities and objects including facial recognition for user orientation and behavior and the identification of objects and objects in motion in comparison with known objects and normal baseline activity. The detection measures include predictive active screen captures and analysis, lack of baseline user or operator in front of the screen, unexpected facial detection and frequency, object detection and frequency and baseline analysis.

Monitored activity for the establishment of baseline activity and the identification of abnormal activity can include facial recognition, object capture, screen capture, behavior timestamps both normal and abnormal.

Abnormal facial recognition data and object in motion data is then used to: determine if a camera is being used for suspected espionage, i.e., by attempting to take a picture of a device screen; determine if computer device display is left unattended, i.e., by baseline user leaving the computer device proximity; determine if person(s) besides the baseline user are observing the computer device display, i.e., by faces observing display behind the baseline user; determine if credentials are used by an unexpected person, i.e., by unexpected person logging into the computer device that does not match baseline user; determine unsafe work environment, i.e., when frequency of facial data exceeds threshold

The detection of abnormal activity can also trigger predefined or preconfigured actions on the device to protect the device. This includes screen blackout, screen lock, user warning, policy reminder, and administrative interactive switches.

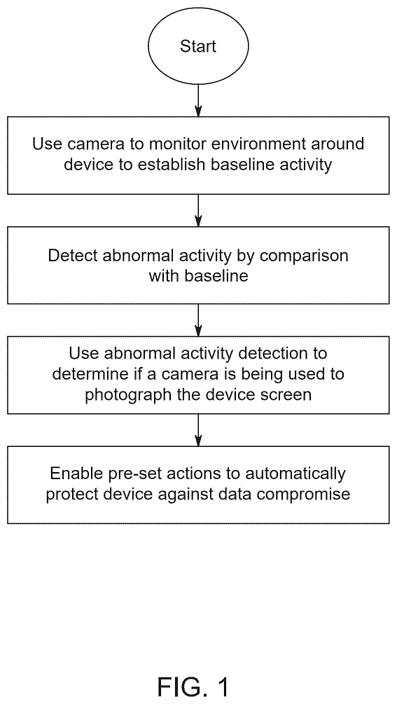

FIG. 1 is a flow chart showing an embodiment of the invention. FIG. 1 shows using a video input component to monitor the environment around the computer device to establish baseline activity; detecting abnormal activity by comparison with the baseline activity; using abnormal activity detection to determine if the object with image capturing capability is being used for possible espionage, i.e., to take a photograph of the device screen; and enabling preconfigured actions to automatically protect the device against data compromise.

Establishing a baseline of common users based on facial recognition can be done without having the user's identity preconfigured on the device. Utilizing the facial recognition includes determining individual orientation and behavior including use of objects, whether someone is looking at a device screen, and user keyboard actions.

### Baseline Activity

Establishing a baseline of normal or typical activity includes identifying objects in use or in motion in the vicinity of the device particularly including identifying objects with image capturing capability. The object with image capturing capability.

The process begins with user login and establishment of baseline. In embodiments, the application may have a stealthy client agent that is deployed with system or root privileges. The client can be deployed either on a physical computing device or a virtual computer device. The application can run at boot, conduct initialization, establish communication with a client back-end server for updates, registration information, and integrations, etc. Storage can be initialized for capability to work off-line and to provide other related backgrounds resources. The (client agent) application can wait for the login of a user which can either be on a physical or virtual host OS (such as Virtual Desktop Infrastructure (VDI), Virtual Machine (VM), etc.). Login of the user can either be done at the physical device interface or can be a remote connection (RDP, etc.) from another physical device. When a user logs in, the application conducts a number of functions upon successful login and establishes a baseline. The system can detect if the user is logged in from a different computer device/host. If that is the case, it requests the user to allow access to the source host that user is logging in from and establishes the video input component with those devices. In the event that video input component access is not granted, preconfigured actions are executed that can even disconnect the remote session, log users out of the session, etc.

The application then starts the video device(s) and the computer behavior/analytic detection process. The application then identifies all video devices and defines the default input component either based on predefined configuration(s) or behavior analysis that is conducted via sampling data and video analytics. The application can create a video proxy service for the selected device that allows multi-streaming of video content (by duplicating device process of the default input component and changing the stream settings, such as dynamic bitrate, frames per second, resolution, delta change detection, etc.), which prevents failure of other processes requesting access to the video input component. Baseline is used throughout the session to identify events and discover indicators of compromise. Baselining is done to provide for reduction of false positives and better anomaly detection, including environment changes.

Establishing a baseline can include the following: environment identification, object identification, video object or device identification, and face identification. Environment identification includes object and facial detection including detecting multiple faces in the vicinity of the device as well as objects in the vicinity of device. In particular, objects that are photo capable are detected.

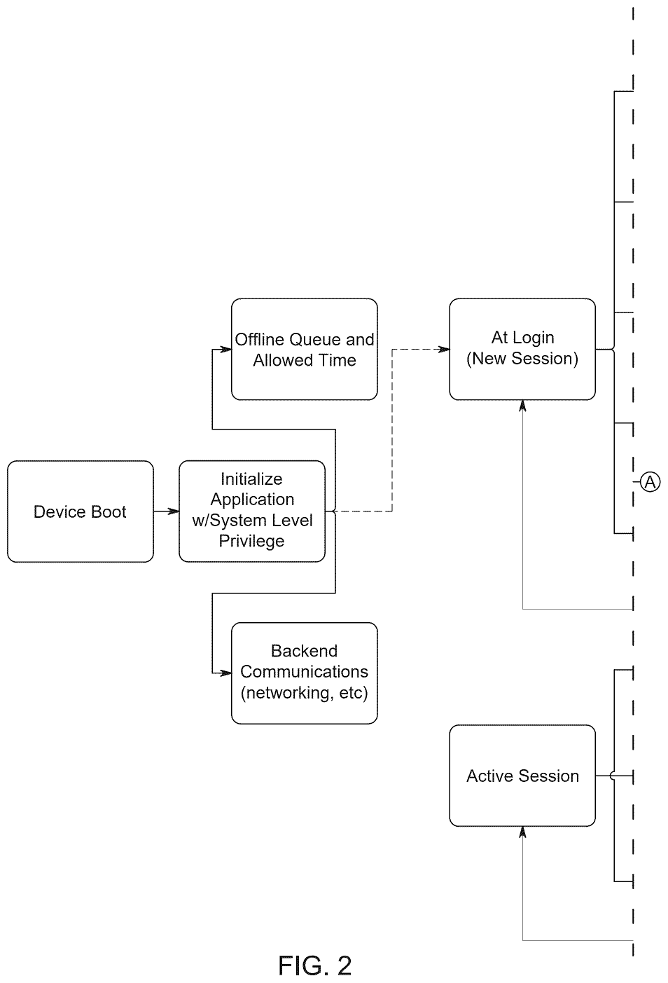

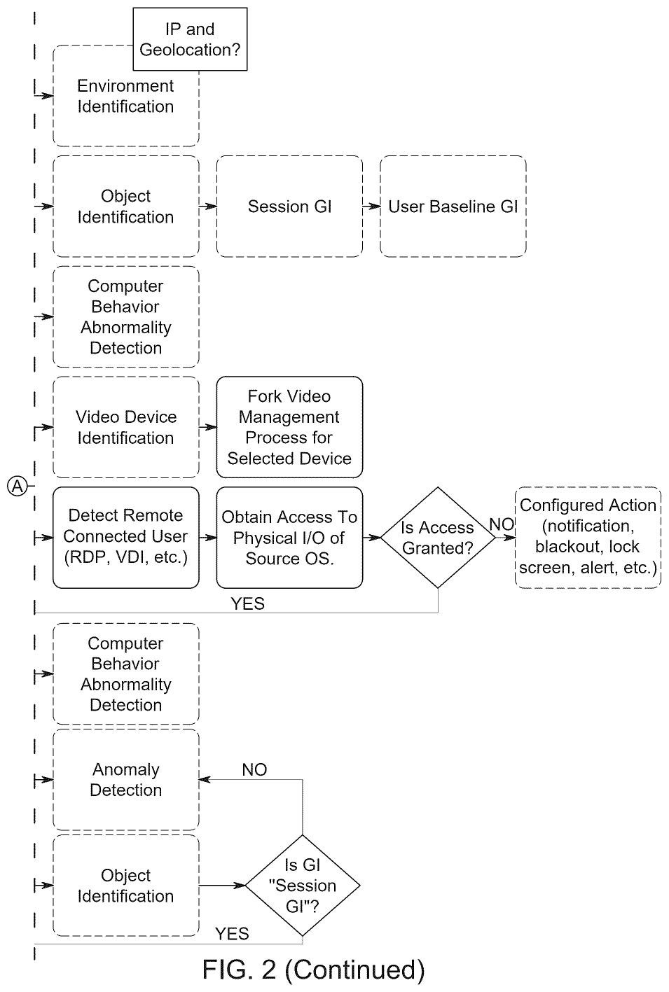

FIG. 2 is a flowchart showing an example startup and login process.

### Anomaly Detection

After the initial login of the user, and baseline is established, the session can be managed as an Active Session, i.e., until the user either logs off the computing device or the computing device is rebooted. During Active Session, the application monitors and detects anomalies or indications of compromise. The object identification and anomaly detection functionality can run in the background. In addition, the application will run computer behavior abnormality detection to identify any hindrance to the application's ability to monitor.

Anomaly detection includes monitoring the physical environment for changes that may indicate a potential threat. When anomalies are detected or indications of compromise are logged, evidence is then stored, the user is notified of compromise via on-screen message, SMS, e-mail, phone call, etc. based on configuration, and/or depending on configuration, alerts sent out. Alerts can be sent to the administration server and/or central event/log aggregation point for root cause analysis and action, as well as other actions that are available.

Anomaly detection can include the following: operator is moving with the device while it is unlocked; multiple people looking at the screen; baseline user has moved away from the screen, leaving the device unlocked; the environment that the user is working in is very public and prone to data exposure; detection of multiple personas sharing credentials or credential theft; detecting potential video capable objects being used either against policy and/or while sensitive data is on the open screen.

Data attribution will be configurable and achieved by integration with enterprise data classification technology and/or use of Optical Character Recognition technology.

Active session includes identifying users and objects in the vicinity of the device. Active session can perform a comparison of identified personas including identifying personas that are not common on the device. Active session can use the identification of non-common users to detect credential theft and unusual activity.

The determination of anomalies or abnormal activity is done by performing a comparison between active session activity and baseline session activity based on object identification and facial recognition including determining individual orientation and behavior and use of objects, determining whether an individual is looking at a device screen, and user keyboard actions. Based on the identification of non-common personas and the comparison of user activity based on facial recognition, the application identifies whether a non-common persona is using an object with a camera to take a picture of the device screen. If an anomaly is detected, preconfigured actions on the device are enabled to automatically protect the device against data compromise.

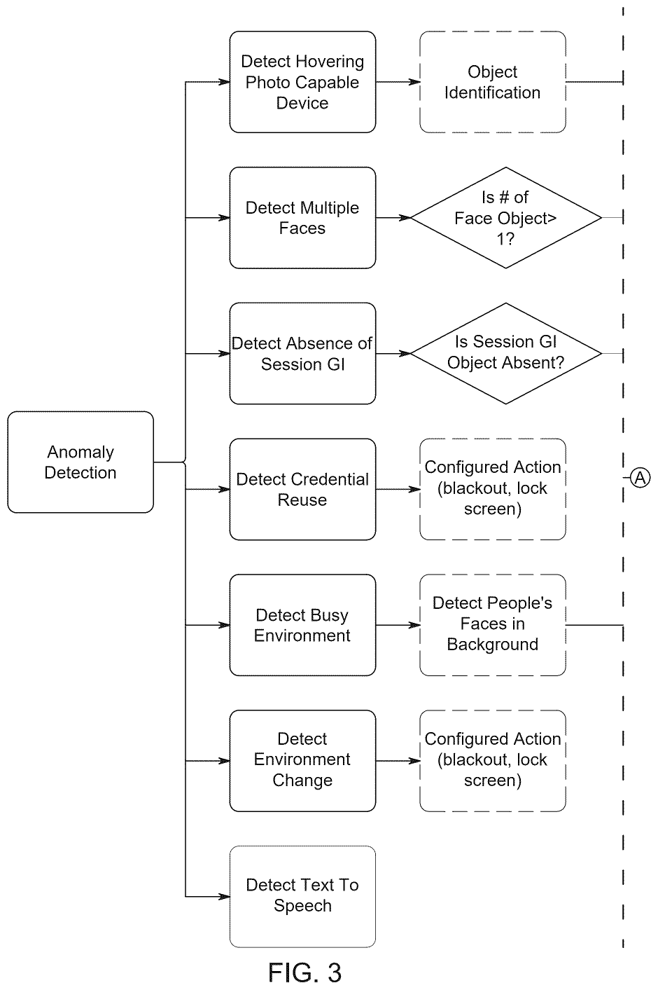

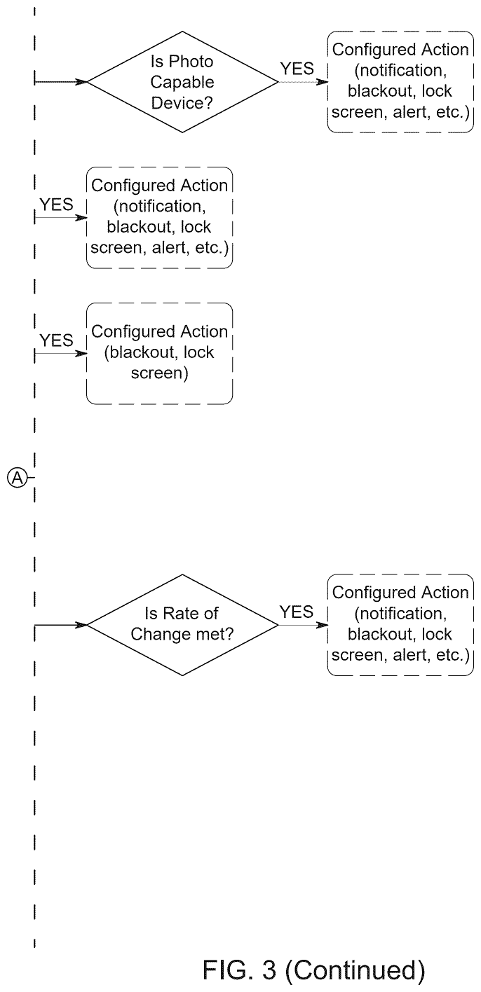

FIG. 3 is a flowchart showing an example of anomaly detection.

Computer behavior abnormality detection is designed to detect when something is obstructing the application's ability to function properly. This can detect if permissions to the default video input component have been blocked, the default input component is missing, malfunctioning, or damaged, the default input component is obstructed, a static image has been injected into the default input component, or issues with the application hosting environment.

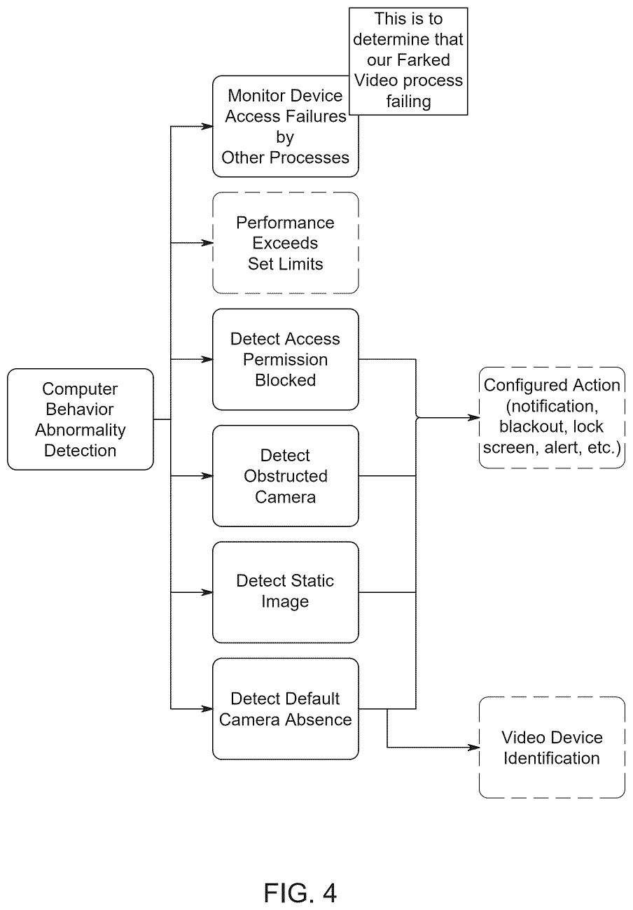

FIG. 4 is a flowchart showing example computer behavior abnormality detection.

Object identification consists of transforming the biometric image of a detected face or photo capable device into a unique digital signature (GI). The face object GI are used in establishing baseline identity at login for managing the user session, as well as building user baseline through behavior on the computing device.

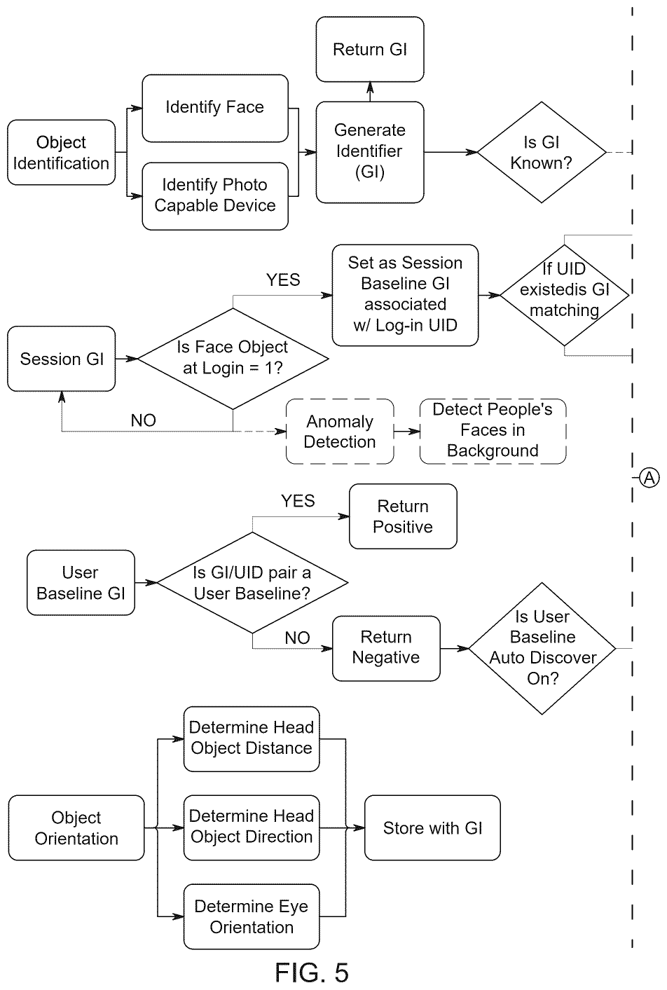

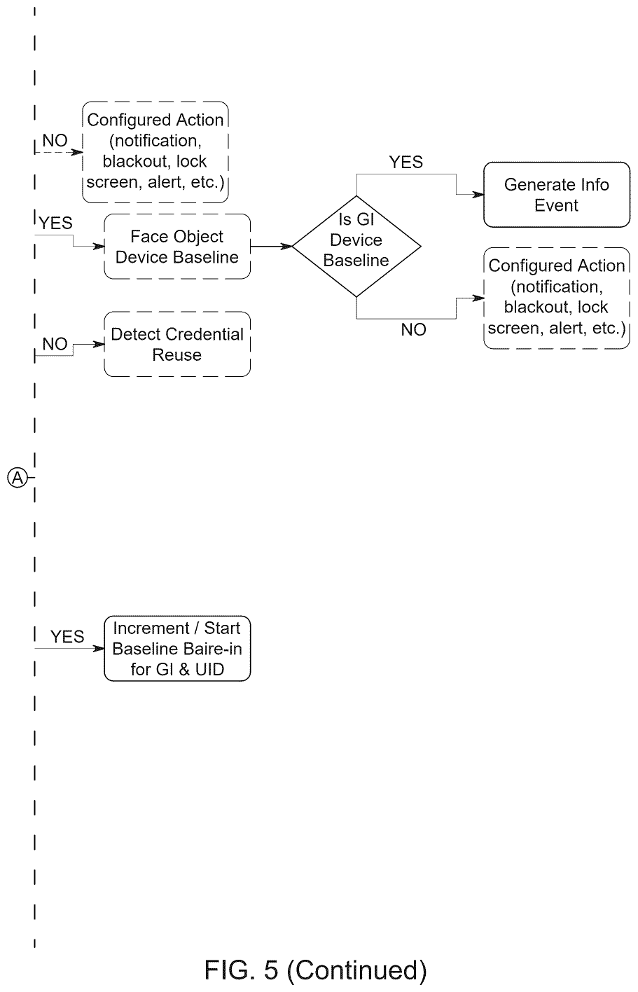

FIG. 5 shows an exemplary object identification process.

The application will utilize additional capabilities to baseline the environments (measuring environment ambiance, calibrating some image settings, etc.) that each user frequents with the computer device. Video Device Identification functionality will allow for behavior analytics to drive default video input component selection, if default is not configured or if the default device is not available. The application will also have a number of configurable actions provided by a configured actions function. This will include screen visibility manipulation and locking of session; termination of remote connections; on screen notifications with/without user response; event/alert creation; screen capture and OCR content detection.

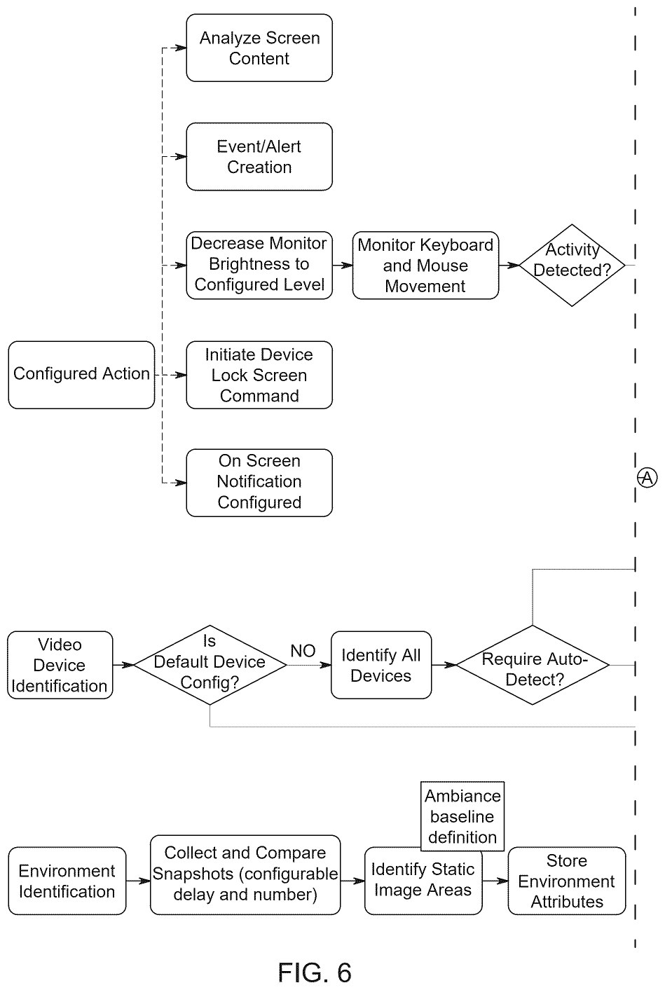

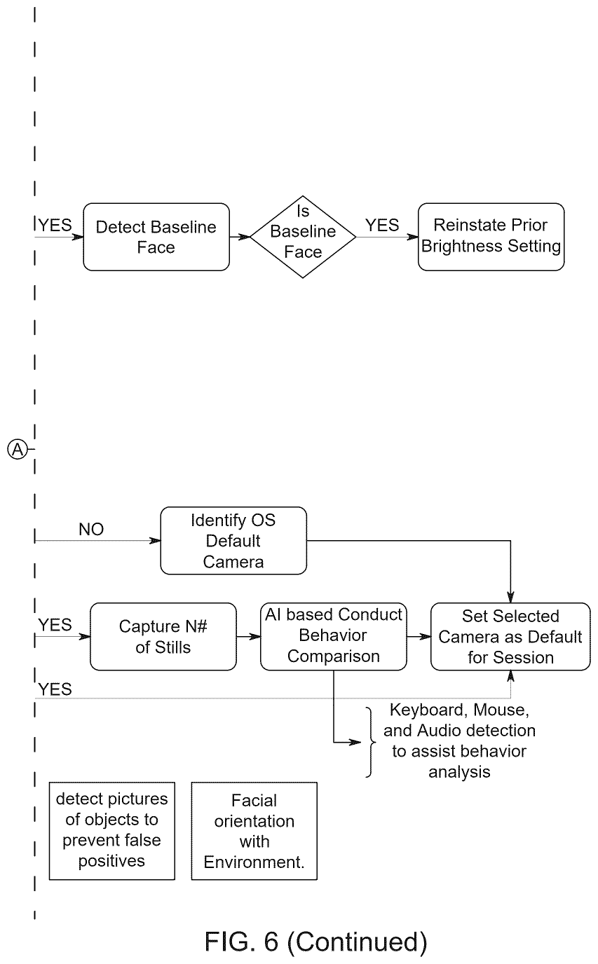

FIG. 6 shows exemplary configured action processes; exemplary video to face identification processes; and environment identification processes.

### EXAMPLE

This system is a state-of-the-art, real-time object detection model that has the advantages of speed and accuracy. The system leverages advanced machine learning techniques, such as deep learning models for facial recognition and image classification for object detection, along with behavioral analytics to monitor user activities, analyze patterns, and predict behaviors. This example shows how the system detects objects such as cell phones, faces, shoulder surfers, credential sharers, etc.

### Input Processing

Frame Extraction: For video input, frames are extracted from the video stream at a defined rate.

Preprocessing: Each frame is resized to a fixed dimension required by the model (e.g., 640×640 pixels) and normalized to ensure the pixel values are within a suitable range (e.g., 0 to 1).

### Model Architecture

Backbone: the system uses a convolutional neural network (CNN) backbone to extract hierarchical features from the input images. This backbone can be a standard architecture like OpenCV, CSPDarknet, EfficientNet, or others, optimized for both speed and accuracy.

Neck: The neck aggregates and enhances features extracted by the backbone. This involves feature pyramid networks (FPNs) or path aggregation networks (PANs) to handle multi-scale feature maps, improving detection of objects at various scales.

Head: The head of the network predicts bounding boxes and class probabilities for each object in the image. This involves regression to predict bounding box coordinates and classification to assign a probability to each class.

### Detection Process

Anchor Boxes: the invention uses predefined anchor boxes that serve as starting points for bounding box predictions. These anchors help the model handle objects of different sizes and aspect ratios.

Bounding Box Prediction: The model predicts offsets relative to the anchor boxes to refine the bounding box locations. It also predicts confidence scores indicating the likelihood that a bounding box contains an object.

Class Prediction: Simultaneously, the model predicts the class probabilities for each bounding box, indicating what type of object is present.

### Post-Processing

Non-Maximum Suppression (NMS): the system applies NMS to remove redundant bounding boxes for the same object. It keeps the bounding box with the highest confidence score and discards others that overlap significantly.

Thresholding: Bounding boxes with confidence scores below a certain threshold are discarded to filter out low-confidence detections.

### Output

The final output for each frame includes a list of detected objects with their bounding box coordinates, confidence scores, and class labels.

### Inference on Video

Frame-by-Frame Detection: the system processes each frame of the video independently to detect objects in real-time. This ensures that it can handle dynamic and moving objects within the video.

Tracking (Optional): While the system itself is primarily for detection, additional tracking algorithms (like SORT or Deep SORT) can be used in conjunction to track objects across frames, maintaining object identities over time.

### Customer-Fed Video Models

When a user provides their own video models (i.e., video data), the system model can be fine-tuned or retrained on this specific data to improve performance for particular use cases. The steps generally involve:

Data Annotation: users need to annotate their video data, providing bounding boxes and class labels for the objects of interest.

Model Training/Fine-Tuning: Using the annotated data, the system can be trained or fine-tuned to learn the specific characteristics of the objects and environments in the customer-provided videos.

Inference: After training, the customized model can be deployed to process new videos, accurately detecting and classifying objects as per the training data.

This approach ensures that the system can be adapted to a wide variety of applications, from surveillance and security to autonomous driving and retail analytics.

### EXAMPLE 2

### Photography Enabled Device Identification

### Detailed Description:

### Video Capture Module

The Video Capture Module consists of onboard or attached camera(s) installed and active on end-user devices. These cameras can vary in quality, including high-definition cameras and those with lower resolutions or older functionalities. The system is designed to accommodate various camera types to ensure comprehensive coverage. The captured video frames are then transmitted to the Face Detection Module for further processing. The frame rate is dynamically managed based on the camera device, hardware/OS performance, and resource utilization to optimize performance.

### Object Detection Module

The Object Detection Module employs convolutional neural networks (CNNs) to analyze each video frame and detect objects. The detection process involves the following steps:

Pre-processing: The video frames are pre-processed to enhance image quality. This may involve noise reduction, contrast adjustment, and normalization.

Object Detection: The pre-processed frames are fed into the trained CNN model, which identifies and locates objects within the frame. The model outputs bounding boxes around detected objects.

### Identification Module

Once objects are detected, the Identification Module assigns a unique identifier to each object. This process includes:

Feature Extraction: Features such as shape, size, color, and texture are extracted from the detected objects. These features are used to create a unique signature for each object.

Initial Identification: The system checks if the detected object has been seen before by comparing its features against a database of previously identified objects.

### Seen Before: If a Match Is Found, the Object Retains its Previously Assigned unique identifier.

Not Seen Before: If no match is found, a new unique identifier is assigned to the object, and its features are stored in the database for future reference.

Database Maintenance: The database of identified objects and their features is continuously updated as new objects are detected and identified.

Capability Determination: The system further analyzes the detected object to determine if it has video or photo capabilities. This process involves:

Shape and Design Analysis: Certain shapes and designs are indicative of devices with video or photo capabilities, such as smartphones, digital cameras, or camcorders.

Component Detection: The presence of components such as lenses, viewfinders, or screens can be used to infer the capabilities of the object.

Feature Matching: Comparing the detected object's features against a database of known devices with video or photo capabilities and/or trained model to confirm its functionality.

Usage Detection: The system also determines if the camera component is actively being used by detecting specific indicators such as the LED light or flashlight. This process includes:

Light Source Detection: Analyzing the video frames for bright light sources that are consistent with LED or flashlight indicators.

Position Analysis: Confirming that the detected light sources are located at positions typical for camera indicators on devices.

Behavioral Patterns: Observing the on-off patterns of the light sources to differentiate between incidental light and intentional camera usage.

Eye tracking: Observing the eye movement of the user can determine if the camera is active if they are looking at the camera while raising it to the screen—even if no light or LED is detected

Screen Content Determination: The system can determine the content on the screen of detected devices. This process involves:

Screenshot Capture: Capturing a screenshot of the device's screen to analyze the content being displayed.

Optical Character Recognition (OCR): Using OCR to extract text and other readable elements from the screenshot.

Application and File Detection: Identifying the applications and files that are open on the screen by analyzing the icons, window titles, and other UI elements.

Window Position Analysis: Determining which applications and files are in the foreground by analyzing the z-order of the windows and their positions relative to each other.

Content Context Analysis: Analyzing the content of the detected applications and files to understand their context, such as whether a document is being edited, a video is being played, or a communication app is in use.

Content Data Classification: According to the OCR results, the data can be labeled as containing GDPR, PII, PCI, HIPAA and other categories such as Passwords, which would indicate a higher severity breach when used in combination with usage detection. The content data classification can further be derived from integration with corporate Data Security Posture Management Tool(s).

### Tracking Module

The Tracking Module is responsible for tracking the movement of identified objects across successive frames. This is achieved through the following steps:

Prediction: The module predicts the position of each object in the next frame using algorithms such as Kalman filtering or optical flow. These predictions are based on the object's current trajectory and motion patterns.

Update: The actual position of objects in the next frame is detected, and the predicted positions are updated accordingly. The module adjusts the object's position and maintains the unique identifier.

Handling Occlusions: The system handles cases where objects are temporarily obscured from view. When an object reappears, the system re-identifies it using its unique features and resumes tracking.

Continuity Maintenance: The module ensures continuous tracking of objects, even as they move in and out of the camera's field of view. If an object leaves the view, the tracking record is updated to indicate the object's last known position and time.

### Proximity and Orientation Determination

To determine the proximity and orientation of the detected device in comparison with other objects in the frame, the system utilizes the following steps:

Distance Calculation: The system calculates the distance between the detected device and other objects in the frame. This is done using the coordinates of the bounding boxes around the objects and applying geometric algorithms to determine the relative distances.

Proximity Analysis: Based on the calculated distances, the system classifies the proximity of the device to other objects as close, moderate, or distant. This classification can be used to infer potential interactions or relevance between objects.

Orientation Detection: The orientation of the device is determined by analyzing its alignment with respect to the frame and other objects. This involves:

Edge Detection: Using edge detection algorithms to determine the angles and orientation of the device.

Component Positioning: Analyzing the position of key components such as screens or lenses to infer the front, back, top, and bottom of the device.

Pose Estimation: Applying pose estimation techniques to understand the 3D orientation of the device in the frame.

Interaction Analysis: The system also evaluates potential interactions between the device and other objects based on their proximity and orientation. For example, if a smartphone is oriented towards the screen based on face object orientation, the system may infer that the information on screen is being photographed or scanned.

### Data Storage Module

The Data Storage Module stores comprehensive information related to each detected, identified, and tracked object. This includes:

Timestamped Video Frames: Each frame is stored with a timestamp to maintain the sequence of events.

Bounding Box Coordinates: The coordinates of the bounding boxes around detected objects are stored to keep track of their positions within the frame.

Unique Identifiers: Each object is associated with a unique identifier that is maintained throughout the tracking process for each client agent.

Object Feature Data: Detailed features of each object, including shape, size, color, and texture, are stored for identification purposes.

Capability Data: Information on the object's video or photo capabilities is stored for each identified object.

Usage Data: Data on the active usage of camera components, including LED or flashlight indicators, is stored.

Proximity and Orientation Data: Data on the proximity and orientation of the device in relation to other objects in the frame is stored.

Screen Content Data: Data extracted from screenshots, including OCR findings, detected applications, files, and their positions, are stored locally without leaving the client network.

Tracking Data: The module stores data related to the object's movement across frames, including velocity, direction, and changes in position.

A system for real-time object detection, identification, and tracking in video streams, comprising:

A video capture module configured to capture video frames.

An object detection module configured to detect objects within the video frames.

An identification module configured to assign unique identifiers to the detected objects, including a process for determining if the detected object has been seen before.

A capability determination process to identify if the detected object has video or photo capabilities.

A usage detection process to determine if the camera component is being used, including detecting LED or flashlight indicators.

A screen content determination process to capture and analyze screenshots, extract text using OCR, and detect open applications and files, including their positions.

A tracking module configured to track the identified objects across successive video frames.

A proximity and orientation determination process to calculate the distance and orientation of the device in relation to other objects in the frame.

A data storage module configured to store data related to the detected, identified, and tracked objects.

The system of claim 1, wherein the object detection module employs convolutional neural networks for object detection.

The system of claim 1, wherein the identification module uses feature extraction and matching algorithms to assign unique identifiers to objects and determine if the object has been previously identified.

The system of claim 1, wherein the identification module further includes a capability determination process that analyzes the object's shape, components, and matches features against a database to identify video or photo capabilities.

The system of claim 1, wherein the usage detection process includes light source detection, position analysis, and behavioral pattern observation to determine active camera use.

The system of claim 1, wherein the screen content determination process includes screenshot capture, OCR analysis, and the detection of open applications and files, including their positions and z-order.

The system of claim 1, wherein the tracking module utilizes Kalman filtering or optical flow algorithms for tracking objects.

The system of claim 1, wherein the proximity and orientation determination process includes user sex identification, age range, emotional state and can combine this calculation with edge detection, component positioning, and pose estimation.

The system of claim 1, wherein the data storage module stores timestamped video frames, bounding box coordinates, unique identifiers, object feature data, capability data, usage data, proximity and orientation data, screen content data, and tracking data.

### Detailed Description for Face Detection System

### Video Capture Module

The Video Capture Module consists of onboard or attached camera(s) installed and active on end-user devices. These cameras can vary in quality, including high-definition cameras and those with lower resolutions or older functionalities. The system is designed to accommodate various camera types to ensure comprehensive coverage. The captured video frames are then transmitted to the Face Detection Module for further processing. The frame rate is dynamically managed based on the camera device, hardware/OS performance, and resource utilization to optimize performance.

### Face Detection Module

The Face Detection Module employs convolutional neural networks (CNNs) to analyze each video frame and detect faces. The detection process involves the following steps:

Pre-processing: The video frames are pre-processed to enhance image quality. This may involve noise reduction, contrast adjustment, and normalization, depending on the camera quality.

Face Detection: The pre-processed frames are fed into the trained CNN model, which identifies and locates faces within the frame. The model outputs bounding boxes around detected faces.

### Identification Module

Once faces are detected, the Identification Module assigns a unique identifier to each face. This process includes:

Feature Extraction: Features such as facial landmarks, shape, size, and texture are extracted from the detected faces. These features are used to create a unique signature for each face.

Initial Identification: The system checks if the detected face has been seen before by comparing its features against a database of previously identified faces.

Seen Before: If a match is found, the face retains its previously assigned unique identifier.

Not Seen Before: If no match is found, a new unique identifier is assigned to the face, and its features are stored in the database for future reference.

Database Maintenance: The database of identified faces and their features is continuously updated as new faces are detected and identified.

### Capability Determination

The system analyzes the detected faces to determine specific capabilities or characteristics, such as:

Expression Analysis: Identifying facial expressions to understand emotional states.

Age Estimation: Estimating the age of the detected faces.

Gender Identification: Determining the gender of the detected faces.

Pose Estimation: Understanding the orientation of the face (e.g., frontal, profile).

### Usage Detection

The system determines if the detected face is actively interacting with the device by detecting specific indicators such as gaze direction. This process includes:

Gaze Detection: Analyzing the direction of the gaze to infer if the face is looking at the camera or another object.

Blink Detection: Identifying blinking patterns to assess engagement.

Screen Content Determination The system can determine the content on the screen that the face is interacting with. This process involves:

Screenshot Capture: Capturing a screenshot of the device's screen to analyze the content being displayed.

Optical Character Recognition (OCR): Using OCR to extract text and other readable elements from the screenshot.

Application and File Detection: Identifying the applications and files that are open on the screen by analyzing the icons, window titles, and other UI elements.

Window Position Analysis: Determining which applications and files are in the foreground by analyzing the z-order of the windows and their positions relative to each other.

Content Context Analysis: Analyzing the content of the detected applications and files to understand their context, such as whether a document is being edited, a video is being played, or a communication app is in use.

### Tracking Module

The Tracking Module is responsible for tracking the movement of identified faces across successive frames. This is achieved through the following steps:

Prediction: The module predicts the position of each face in the next frame using algorithms such as Kalman filtering or optical flow. These predictions are based on the face's current trajectory and motion patterns.

Update: The actual position of faces in the next frame is detected, and the predicted positions are updated accordingly. The module adjusts the face's position and maintains the unique identifier.

Handling Occlusions: The system handles cases where faces are temporarily obscured from view. When a face reappears, the system re-identifies it using its unique features and resumes tracking.

Continuity Maintenance: The module ensures continuous tracking of faces, even as they move in and out of the camera's field of view. If a face leaves the view, the tracking record is updated to indicate the face's last known position and time.

### Proximity and Orientation Determination

To determine the proximity and orientation of the detected face in comparison with other objects in the frame, the system utilizes the following steps:

Distance Calculation: The system calculates the distance between the detected face and other objects in the frame. This is done using the coordinates of the bounding boxes around the objects and applying geometric algorithms to determine the relative distances.

Proximity Analysis: Based on the calculated distances, the system classifies the proximity of the face to other objects as close, moderate, or distant. This classification can be used to infer potential interactions or relevance between objects.

Orientation Detection: The orientation of the face is determined by analyzing its alignment with respect to the frame and other objects. This involves:

Edge Detection: Using edge detection algorithms to determine the angles and orientation of the face.

Component Positioning: Analyzing the position of key facial features such as eyes, nose, and mouth to infer the orientation.

Pose Estimation: Applying pose estimation techniques to understand the 3D orientation of the face in the frame.

Interaction Analysis: The system also evaluates potential interactions between the face and other objects based on their proximity and orientation. For example, if a face is oriented towards a screen, the system may infer that the person is interacting with the screen.

### Detection of Same or Different Position and Orientation

To ensure maximum accuracy in detecting if an identified person is in the same or different position and orientation compared to prior recorded identities, the system employs multiple methods:

Historical Data Comparison: Comparing the current detected position and orientation with previously recorded data for the same unique identifier.

Facial Landmark Analysis: Analyzing the relative positions of facial landmarks such as eyes, nose, and mouth across different frames to detect changes in orientation.

Pose Consistency Check: Using pose estimation algorithms to determine if the overall pose (e.g., frontal, profile) remains consistent with previous records.

3D Model Matching: Creating a 3D model of the face based on detected features and comparing it with stored 3D models to identify changes in orientation and position.

Movement Pattern Analysis: Tracking the movement patterns of the face across frames to determine if the person has shifted position or orientation.

Gaze and Blink Patterns: Monitoring gaze direction and blink patterns as additional indicators of orientation changes.

Proximity Changes: Analyzing changes in proximity to other objects in the frame to infer positional shifts.

Temporal Consistency: Ensuring that the detected changes in position and orientation are consistent over multiple frames to avoid false positives due to momentary changes or occlusions.

Environmental Context: Utilizing the surrounding environment to enhance the determination of the same or different position and orientation. This involves:

Background Analysis: Analyzing the background and surroundings of the face to determine consistency with previous frames.

Object Interactions: Observing interactions with nearby objects (e.g., chairs, tables) to assess changes in position.

Lighting Conditions: Considering changes in lighting and shadows that might affect the appearance and perceived orientation of the face.

User Identity Association and Verification

The system also incorporates user identity verification by associating facial identities with user login information. This process includes:

User Identity Association: During the user login process, the system captures the user's facial features and associates them with their login credentials (e.g., username) and/or credentials that are preconfigured as default by the administrator and/or via integration with corporate Identity and Access Management System (IAMS).

Storage of Facial Identity: The captured facial features are stored in the database along with the user's login credentials for future reference.

Login Verification: During subsequent login attempts, the system captures the user's facial features and compares them with the stored facial identity associated with the provided login credentials.

Mismatch Detection: If the system detects a different facial identity being used with the same login credentials, it flags this as a potential security concern. This involves:

Feature Comparison: Comparing the newly captured facial features with the stored features for the same user identity.

Alert Generation: Generating an alert if a mismatch is detected, indicating that a different person is attempting to use the same login credentials.

Historical Analysis: The system can perform historical analysis to identify patterns of mismatched facial identities with the same login credentials over time, which can be used for security audits and investigations.

### Host and Remote Login Detection

The system captures information about the host device on which the application is running, and if the login is remote, it captures details about the remote hosts used to authenticate to the device. This includes:

Host Device Information: Capturing details such as the device name, IP address, operating system, and hardware specifications of the host device.

Remote Login Detection: Identifying if the login attempt is being made remotely and capturing the details of the remote device, including its IP address, device name, and operating system.

Access Request Management: The application requests access to the device input/output resources where the login attempt is originating from, ensuring that the remote computing device is authorized to access the system. This involves:

Authorization Checks: Ensuring that the remote device has the necessary permissions to access the host system physical input/output devices.

Security Protocols: Implementing security protocols to protect against unmonitored access and ensuring continuous monitoring of active session.

### Data Storage Module

The Data Storage Module stores comprehensive information related to each detected, identified, and tracked face. This includes:

Timestamped Video Frames: Each frame is stored with a timestamp to maintain the sequence of events.

Bounding Box Coordinates: The coordinates of the bounding boxes around detected faces are stored to keep track of their positions within the frame.

Unique Identifiers: Each face is associated with a unique identifier that is maintained throughout the tracking process.

Face Feature Data: Detailed features of each face, including facial landmarks, shape, size, and texture, are stored for identification purposes.

Capability Data: Information on the face's characteristics, such as expression, age, and gender, is stored.

Usage Data: Data on the active engagement of the face, including gaze direction and blinking patterns, is stored.

Proximity and Orientation Data: Data on the proximity and orientation of the face in relation to other objects in the frame is stored.

Screen Content Data: Data extracted from screenshots, including OCR findings, detected applications, files, and their positions, are stored.

### Event Queue

The system includes an event queue to manage events generated by the detection and analysis processes. This event queue allows the system to handle and prioritize events based on their importance and urgency. Events can be generated based on any subset of the detection capabilities, including face detection, identification, capability determination, usage detection, screen content determination, tracking, proximity and orientation determination, and user identity verification. The event queue ensures that events are processed efficiently, and that the system can respond to critical events promptly.

### GLOSSARY

The environment in proximity to the computer device as used herein generally means the area close enough to the device wherein the device screen can be viewed and information displayed on the device screen can be read. This will depend on the size of the screen. The environment in proximity to the computer device includes an area close enough that a cell phone camera, or the like, could take intelligible pictures of the computer device screen. For a standard desktop or laptop computer, this would include an area up to about 25 feet from the device screen. For a tablet or a cell phone, the environment in proximity to the device would be up to about 10 feet. For a remote connection and virtual computer device, the environment in proximity of the source computer device where the connection originates from.

A user of the computer device is an authorized operator or user of the computer device based on corporate Identity and Access Management program. Typically, the user will login to the computer device using corporate login credentials normally including a password, software or hardware token, biometrics, or another multi-factor prompt.

A non-user of the computer device is any other individual that is in proximity to the computer device and that can potentially see the computer device screen.

A baseline session is a session run by the application wherein a computer device default video input component and associated video analytics is used to obtain user facial data, non-user facial data, and object data to establish normal activity for the environment in proximity to the computer device. This can be done upon startup of the application performed and for mobile devices can be performed each time the device is moved and becomes stationary in a new location. A baseline session for a computer device in a particular location can also be stored in permanent memory and used on subsequent days as well.

An active session is a session performed after the baseline session and is a session run by the application wherein a computer default video input component and associated video analytics is used to obtain user facial data, non-user facial data, and object data and the data is compared with the baseline session to detect anomalous or abnormal events.

Video analytics are computer analytics used to obtain and analyze facial data and object data and typically use machine learning and artificial intelligence (AI) technologies.

A computer device is any device capable of processing data and/or information, such as any general purpose and/or special purpose computer, such as a desktop computer, workstation, server, minicomputer, mainframe, supercomputer, computer terminal, laptop, wearable computer, and/or Personal Digital Assistant (PDA), mobile terminal, Bluetooth device, communicator, “smart” phone, messaging service (e.g., Blackberry) receiver, cellular telephone, a traditional telephone with a display screen, telephonic device, or any virtual instances of the aforementioned computer devices. In general, any computer device with memory and one or more processors, and a graphical user interface, may be a computer device. A computer device can comprise components such as one or more network interfaces, one or more processors, one or more memories containing instructions, and/or one or more input/output (I/O) devices, one or more user interfaces coupled to an I/O device, etc. Input/output (I/O) devices are any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.

While this disclosure includes specific examples, it will be apparent after an understanding of the disclosure of this application has been attained that various changes in form and details may be made in these examples without departing from the spirit and scope of the claims and their equivalents.

1. A method of monitoring the environment in proximity to a computer device comprising a display, for abnormal activity, comprising:
identifying a user of the computer device;
conducting a baseline monitoring session on the computer device comprising using a computer video camera and associated video analytics to obtain user facial data, non-user facial data, and object data to establish normal activity for the environment in proximity to the computer device, wherein the object data enables identification of objects that include a camera;
conducting an active monitoring session on the computer device comprising using a computer video camera and associated video analytics to obtain user facial data, non-user facial data, and object data, wherein the object data enables identification of objects that include a camera;
detecting abnormal activity in the environment in proximity to the computer device by comparing the active monitoring session user facial data, non-user facial data, and object data with the baseline monitoring session user facial data, non-user facial data, and object data, wherein the abnormal activity comprises a non-user using an object comprising a camera to video or photograph the computer device display; and
enabling actions on the computer device to protect the computer device against data compromise.

2. The method of claim 1, wherein the abnormal activity further comprises:
the user moving with the computer device while it is unlocked;
a non-user looking at the computer device display;
the user moving away from the computer device display; or
detecting that the environment in proximity to the computer device is public.

3. The method of claim 1, wherein the computer device is a desktop, laptop, or tablet computer device.

4. The method of claim 1, wherein the video camera is a webcam.

5. The method of claim 1, wherein the actions on the device to protect the device include screen blackout, screen lock, user warning, policy reminder, or administrative interactive switches.

6. The method of claim 1, wherein the actions on the computer device to protect the computer device are preconfigured or predefined prior to conducting the baseline monitoring session.
